(19) United States
(12) Patent Application Publication
(10) Pub. No.: US 2025/0181455 A1
(43) Pub. Date: Jun. 5, 2025

(54) MAINTAINING READ-AFTER-WRITE CONSISTENCY BETWEEN DATASET SNAPSHOTS ACROSS A DISTRIBUTED ARCHITECTURE

(71) Applicant: NETFLIX, INC., Los Gatos, CA (US)

(72) Inventors: John Andrew KOSZEWNIK, Morgan Hill, CA (US); Eduardo RAMIREZ ALCALA, Culver City, CA (US); Govind VENKATRAMAN KRISHNAN, San Jose, CA (US); Vinod VISWANATHAN, San Ramon, CA (US)

(21) Appl. No.: 18/530,138

(22) Filed: Dec. 5, 2023

(51) Int. Cl. G06F 11/14; G06F 16/78

(52) U.S. Cl. CPC G06F 11/1464; G06F 16/2379; G06F 16/27; G06F 16/78; G06F 2201/84

(57) ABSTRACT

In various embodiments a computer-implemented method for modifying snapshots of datasets distributed over a network is disclosed. The method includes receiving a request to modify a record in a snapshot of a dataset, wherein the snapshot comprises a compressed plurality of records replicated across a plurality of applications, and wherein the snapshot is co-located in memory associated with each application. The method further includes duplicating the request across a plurality of buffers, wherein each buffer tracks modification requests associated with the snapshot, and wherein each of the plurality of applications accesses a buffer of the plurality of buffers to receive and store the request in a portion of memory separate from the dataset. The method further includes modifying the snapshot in accordance with the request and transmitting the modified snapshot to the plurality of applications where the modified snapshot replaces the prior copy of the snapshot.

### CROSS-REFERENCE TO RELATED APPLICATIONS

The present application is related to U.S. patent application Ser. No. ______, filed on Dec. 5, 2023, entitled “Maintaining Read-After-Write Consistency Between Dataset Snapshots Across a Distributed Architecture,” naming John Andrew Koszewnik, Eduardo Ramirez Alcala, Govind Venkatraman Kirshnan, and Vinod Viswanathan as inventors, and having attorney docket number NFLX0057US2. That application is incorporated herein by reference in its entirety and for all purposes.

### BACKGROUND

### Field of the Various Embodiments

Embodiments of the present invention relate generally to generating snapshots of datasets and, more specifically, to techniques for maintaining consistency between snapshots of datasets across a distributed architecture.

### Description of the Related Art

In a general video distribution system, there is a stored dataset that includes metadata describing various characteristics of the videos. Example characteristics include title, genre, synopsis, cast, maturity rating, release date, and the like. In operation, various applications executing on servers included in the system perform certain read-only memory operations on the dataset when providing services to end-users. For example, an application could perform correlation operations on the dataset to recommend videos to end-users. The same or another application could perform various access operations on the dataset in order to display information associated with a selected video to end-users.

To reduce the time required for applications to respond to requests from end-users, a server oftentimes stores a read-only copy of the dataset in local random access memory (RAM). In other words, the dataset is co-located in memory. Memory co-location refers to the practice of storing data in a location that is physically close to the processing unit that will be using or manipulating that data. In the context of computing, this often means storing data in the computer's main memory (RAM) rather than storing the data on a separate storage medium like a hard drive or SSD. One of the benefits of memory co-location is that if the dataset is stored in RAM, latencies experienced while performing read operations on the dataset are decreased relative to the latencies experienced while performing read-only operations on a dataset that is stored in a remote location.

One of the challenges that arises with memory co-location across distributed applications (e.g., applications that are part of an enterprise system) or a distributed platform (e.g., a video or content streaming service) is maintaining consistency, and in particular read-after-write (RAW) consistency, between distributed copies of the dataset. In a distributed environment, where data is spread across multiple locations or nodes, maintaining consistency becomes a complex challenge. Generalized methods of memory co-location might not be suitable as those methods do not inherently address the challenges of coordinating and maintaining consistency across distributed systems. Memory co-location, while beneficial for single-node systems or systems that can tolerate eventual consistency, might not translate seamlessly to scenarios where data is distributed across multiple nodes and stronger consistency guarantees are required.

When a dataset is replicated across multiple nodes in a distributed architecture, maintaining RAW consistency is sometimes crucial. With RAW consistency, when data is written to one copy of the dataset, subsequent reads from any copy reflect the most recent write. Generalized methods, which may not be specifically designed for distributed environments, often lack the mechanisms needed to guarantee this kind of consistency. In a distributed system, factors like network latency, node failures, and concurrent updates introduce complexities that need to be addressed to maintain RAW consistency effectively. In summary, generalized methods, whether for memory co-location or maintaining distributed copies of datasets in RAM, may not be well-suited for ensuring the RAW consistency required in distributed architectures.

As the foregoing illustrates, what is needed in the art are more effective techniques for implementing consistency between replicated snapshots of datasets in distributed computing environments.

### SUMMARY

One embodiment sets forth a computer-implemented method for modifying snapshots of datasets distributed over a network. The method includes receiving a request to modify a record in a snapshot of a dataset, wherein the snapshot comprises a compressed plurality of records replicated across a plurality of applications, and wherein the snapshot is co-located in memory associated with each respective application. The method further includes duplicating an entry comprising information associated with the request across a plurality of buffers, wherein each buffer tracks modification requests associated with the snapshot, and wherein each of the plurality of applications accesses a buffer of the plurality of buffers to receive and store the entry in a portion of memory separate from the dataset, wherein the portion of the memory is accessed in response to a read request associated with the record that is received prior to the snapshot being modified in accordance with the request. The method also comprises modifying the snapshot in accordance with the request and transmitting the modified snapshot to the plurality of applications, wherein the snapshot at each of the plurality of applications is replaced with the modified snapshot.

Another embodiment sets forth a computer-implemented method for reading datasets distributed over a network. The method includes receiving a modification of a record at an application of a plurality of applications from an associated buffer of a plurality of buffers, wherein the modification to the record is to be incorporated in a snapshot of a dataset co-located in memory at the application, and wherein the snapshot is replicated across the plurality of applications and comprises a compressed plurality of records. The method further comprises storing information associated with the modification in a portion of memory accessible to the application that is separate from the snapshot. The method also comprises receiving a request to retrieve the record from the snapshot associated with the application. Responsive to a determination that the record is available in the portion of the memory, the method comprises accessing the portion of the memory to respond to the request. Further, the method comprises receiving an updated snapshot, wherein the updated snapshot incorporates the modification to the record, and replacing the snapshot with the updated snapshot.

At least one technical advantage of the disclosed techniques relative to the prior art is that, the disclosed techniques effectively maintain Read-After-Write (RAW) consistency across multiple datasets or snapshots of datasets distributed across several applications or a distributed platform. By ensuring RAW consistency, the disclosed techniques ensure that any update to a snapshot of a dataset, regardless of the application that initiates the update, is immediately reflected in all distributed copies. This consistency is important for applications relying on synchronized, real-time data. Moreover, the utilization of compressed sets of records co-located in memory at each application enhances performance by reducing data retrieval latency. The distributed nature of the system facilitates scalability and fault tolerance, allowing seamless operations even in the face of node failures. The disclosed techniques not only foster a unified and up-to-date view of the data across diverse applications but also streamline development processes by providing a consistent and reliable foundation for data operations, ultimately improving the overall efficiency and reliability of the distributed ecosystem.

Utilizing the disclosed techniques to replace persistent storage by co-locating datasets (or snapshots of datasets) in memory across a distributed architecture offers a range of other compelling advantages. One of the primary advantages is the boost in data access speed. Retrieving information directly from memory is significantly faster than fetching it from traditional disk-based storage, thereby enhancing overall system performance. Additionally, in-memory co-location eliminates the need for disk I/O operations, reducing latency and accelerating data access for critical applications. Furthermore, by storing datasets in RAM, the disclosed techniques minimize the impact of I/O bottlenecks, ensuring that applications experience smoother and more responsive operations. Additionally, the shift to in-memory storage often leads to more efficient resource utilization. RAM offers quicker access times compared to traditional storage media, allowing for rapid data retrieval and processing. This efficiency translates into improved scalability, enabling the system to effortlessly handle growing datasets and increasing workloads. Moreover, the reduced reliance on persistent storage can contribute to cost savings, as organizations may require less investment in high-capacity disk storage solutions.

Moreover, with memory-colocation, problem-solving becomes more straightforward because I/O latency considerations are eliminated. The ability to iterate rapidly on issues allows for the evaluation of multiple potential solutions in a shorter timeframe. With memory co-location, services exhibit fewer moving parts with fewer external dependencies because any data needed by the service is co-located in memory. Because the time to perform typically high-latency operations is reduced, memory co-location allows for the construction of complex problem-solving layers on a robust foundation. This contributes to a more resilient system with simpler operational characteristics. Additionally, the reduction in operational incidents related to performance difficulties stems from the substantial latency and reliability improvement of accessing data from memory compared to traditional I/O methods, whether over the network or from disk. In practical scenarios, co-locating data in memory facilitates simpler problem-solving, faster iteration, enhanced ability to solve complex problems, and a reduction in operational incidents, collectively contributing to a more efficient and reliable system.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system 100 configured to implement one or more aspects of the various embodiments.

FIG. 2 is a more detailed illustration of the system 100 configured to implement one or more aspects of the various embodiments.

FIG. 3 is a more detailed illustration of the dataset writer configured to implement one or more aspects of the various embodiments.

FIG. 4 is a more detailed illustration of a log keeper configured to implement one or more aspects of the various embodiments.

FIG. 5 is a more detailed illustration of client instance configured to implement one or more aspects of the various embodiments

FIG. 6 is an illustration of the manner in which the RAW snapshot engine maintains RAW consistency in a distributed architecture, according to one or more aspects of the various embodiments.

FIG. 7 is a flow diagram of method steps for modifying snapshots of datasets distributed over a network, according to one or more aspects of the various embodiments.

FIG. 8 is a flow diagram of method steps for reading snapshots of datasets distributed over a network, according to one or more aspects of the various embodiments.

FIG. 9 is a block diagram of a server 910 that may be implemented in conjunction with system 100 of FIG. 1, according to various embodiments of the present invention.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. It should be noted that for explanatory purposes, multiple instances of like objects are symbolized with reference numbers identifying the object and letters identifying the instance where needed.

As noted above, in a general video distribution system, there is a stored dataset that includes metadata describing various characteristics of the videos. Example characteristics include title, genre, synopsis, cast, maturity rating, release date, and the like. In operation, various applications executing on servers included in the system perform certain read-only memory operations on the dataset when providing services to end-users. For example, an application could perform correlation operations on the dataset to recommend videos to end-users. The same or another application could perform various access operations on the dataset in order to display information associated with a selected video to end-users.

To reduce the time required for applications to respond to requests from end-users, a generalized server oftentimes stores a read-only copy of the dataset in local random access memory (RAM). In other words, the dataset is co-located in memory. One of the benefits of memory co-location is that if the dataset is stored in RAM, latencies experienced while performing read operations on the dataset are decreased relative to the latencies typically experienced while performing read-only operations on a dataset that is stored in a remote location.

One challenge associated with memory co-location is that, while preserving a read-only copy of the dataset proves effective in scenarios with a single client utilizing the dataset, this approach lacks consistency in a distributed architecture. This limitation becomes apparent when multiple clients aim for consistent outcomes while accessing the co-located dataset within their respective memories across diverse applications. This limitation is particularly pronounced in maintaining consistency between replicated datasets across distributed applications, such as those within an enterprise system, or on a distributed platform like a video streaming service. Achieving read-after-write (RAW) consistency, especially requiring swift accessibility of updates across the distributed applications or platform, poses a significant hurdle. Generalized methods, which may not be specifically designed for distributed environments, might lack the mechanisms to guarantee this kind of consistency. In a distributed system, factors like network latency, node failures, and concurrent updates introduce complexities that need to be addressed to maintain RAW consistency effectively.

Another limitation of storing a conventional dataset in RAM is that, over time, the size of the conventional dataset typically increases. For example, if the video distributor begins to provide services in a new country, then the video distributor could add subtitles and country-specific trailer data to the conventional dataset. As the size of the conventional dataset increases, the amount of RAM required to store the conventional dataset increases and may even exceed the storage capacity of the RAM included in a given server. Further, because of bandwidth limitations, both the time required to initially copy the conventional dataset to the RAM and the time required to subsequently update the copy of the conventional dataset increase.

In response to the ongoing challenge posed by the expanding size of the dataset, the disclosed techniques employ compression methods to efficiently compress the dataset and generate a snapshot. Various compression operations, including, but not limited to, deduplication, encoding, packing, and overhead elimination operations, are applied. In certain embodiments, the source data values within the dataset are transformed into compressed data records based on predefined schemas in the data model. Each compressed data record features a bit-aligned representation of one or more source data values, maintaining a fixed-length format. Notably, these compressed data records facilitate individual access to each represented source data value. Consequently, a snapshot is created, incorporating these compressed records. This approach transforms the source dataset into a snapshot using compression techniques, ensuring that the records within the dataset remain accessible and are sufficiently compact for convenient co-location in memory.

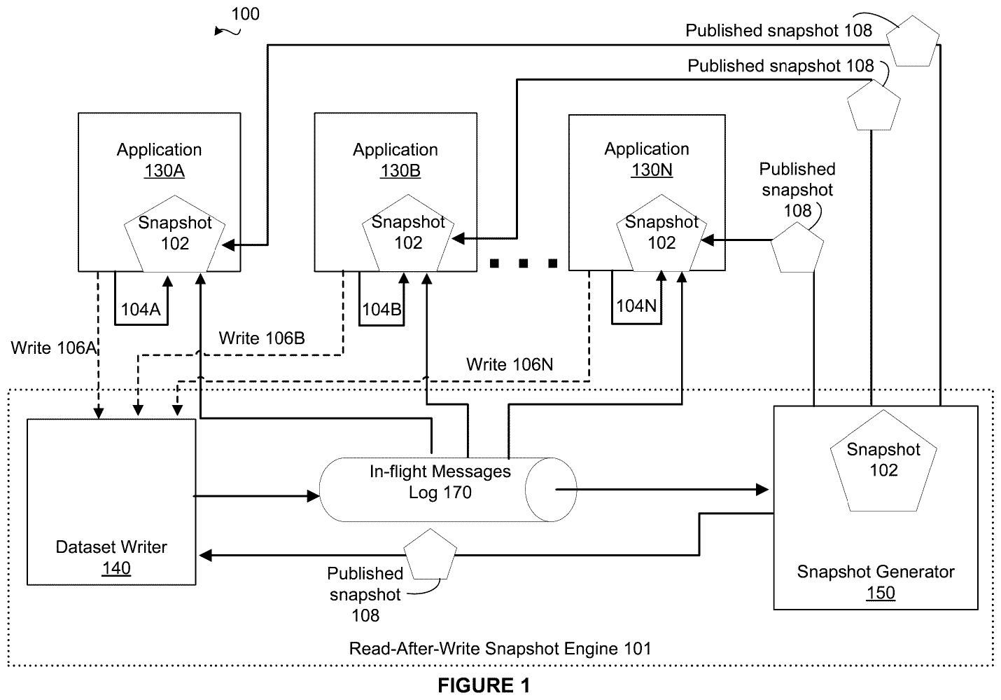

The disclosed techniques also tackle the challenge of scaling memory co-location in a distributed architecture. The disclosed techniques provide a caching and persistence infrastructure specifically tailored for managing small-to mid-sized datasets. The techniques enable the efficient co-location of entire datasets or dataset snapshots in active memory usage, providing low-latency update propagation and supporting RAW consistency as needed. Furthermore, the disclosed methodologies introduce a fully managed distributed system designed to function as a persistence infrastructure. The system discussed in connection with FIG. 1 guarantees high availability, ensuring the safety, durability, and strict serializability of write operations. It also enables fully consistent reads, including direct access from memory, based on operational requirements.

### System Overview

FIG. 1 is a conceptual illustration of a system 100 configured to implement one or more aspects of the various embodiments. As shown, in some embodiments, the system 100 includes, without limitation, applications 130 (e.g., including applications 130A, 130B, . . . 130N) and a read-after-write snapshot engine 101. Each application 130 includes, without limitation, a copy of the snapshot 102. In some embodiments, the RAW snapshot engine 101 and the applications 130 can be deployed in a cloud infrastructure.

Any number of the components of the system 100 can be distributed across multiple geographic locations or implemented in one or more cloud computing environments (e.g., encapsulated shared resources, software, data) in any combination. In some embodiments, the applications (e.g., applications 130A, 130B, 130C, etc.) and compute engines (e.g., read-after-write snapshot engine 101) can be implemented in a cloud computing environment as part of a distributed computing environment.

The read-after-write snapshot engine 101 includes, without limitation, a dataset writer 140, an in-flight messages log 170 and a snapshot generator 150. The snapshot generator 150 generates snapshots from datasets and also includes, without limitation, the snapshot 102. As will be explained further below, the snapshot 102 generated by the snapshot generator 150 is replicated across the applications 130. In some other embodiments, the system 100 can include any number and/or types of other compute instances, other display devices, other databases, other data storage services, other services, other compute engines, other input devices, output devices, input/output devices, search engines, or any combination thereof.

In some embodiments, the RAW snapshot engine 101 enables a persistence architecture that allows snapshots 102 to be persisted across the applications 130 while maintaining RAW consistency. By enabling a persistence architecture, the RAW snapshot engine 101 preempts the need for persistent storage using in generalized systems. In some embodiments, the RAW snapshot engine 101 enables a persistent storage system that is used by the applications 130 (and the reading and writing instances included therein).

Illustrated in FIG. 1, each application 130 (e.g., applications 130A, 130B, . . . 130N) hosts a copy of the dataset snapshot 102, co-located in memory with its respective application 130. Within each application 130, a client instance (not shown) facilitates the reading of one or more data records from the snapshot 102, utilizing a corresponding local read 104 (e.g., 104A for application 130A, 104B for application 130B, . . . 104N for application 130N). The client instances (which include reading application instances) included in the applications 130 have the entire dataset snapshot 102 loaded into their own RAM for low latency access to the entire breadth of the records stored in the snapshot 102.

In some embodiments, the snapshot generator 150 periodically updates the snapshot 102 at set intervals (e.g., every 30 seconds), and these refreshed snapshots, labeled as 108, are distributed to the applications 130. Consequently, the existing snapshots 102 in the applications are replaced with the published snapshot 108 generated periodically by the snapshot generator 150. This ensures that when a local read 104 is executed by a client associated with any application 130, the result remains consistent, regardless of the specific application where the read is performed.

In certain scenarios, one of the applications 130 may require writing to or updating one or more records (e.g., adding, modifying, deleting or conditionally updating a record) within snapshot 102, while the other applications 130 initially lack visibility into this update. For instance, each application 130 can independently execute a write 106 (e.g., write 106A by application 130A, write 106B by application 130B, . . . write 106N by application 130N) without coordination with other applications. When a write 106 occurs, it is essential for the updated record to be promptly reflected across the snapshots 102 at each of the applications 130, ensuring consistency for subsequent reads. The described techniques leverage the read-after-write snapshot engine 101 to update snapshots, allowing the preservation of RAW consistency. Note that while the discussion herein revolves around applications 130 having the capability for both reads and writes, it is important to note that each application can function exclusively as a read-only application or a write-only application.

In some embodiments, a write 106 from an application 130 is transmitted to the dataset writer 140. Upon receipt, the dataset writer 140 creates an entry in an in-flight messages log 170. The in-flight messages log 170 comprises one or more circular buffers or arrays, referred to herein as “log keepers,” for tracking in-flight updates that have not yet been reflected in the dataset snapshot 102 but that need to be accounted for when responding to read requests accessing the snapshots 102. After recording the new entry in the in-flight message log 170, the in-flight messages log 170 forwards the updates to any listening applications 130. In various embodiments, the updates are forwarded to the listening applications 130 immediately after the entry is recorded in the in-flight message log 170. Asynchronously from the listening applications 130, a snapshot generator 150 polls the in-flight messages log 170 for the most recent entries. In other words, the entry with the updates to the dataset represented as snapshot 102 is transmitted by the in-flight messages log 170 instantaneously to each of the applications 130. Additionally, the snapshot generator 150 also receives the updates on a different polling schedule than the applications 130.

In some embodiments, as mentioned above, the snapshot generator 150 updates the snapshot 102, periodically at set intervals (e.g., every 30 seconds) or according to any update regime, and these refreshed snapshots, labeled as 108, are distributed to the applications 130. In various embodiments, the snapshot generator 150 compacts and incorporates the updates reflected in the entry into the base dataset and generates an updated published snapshot 108 that replaces the prior snapshot 102.

In some embodiments, at each of the applications 130, the entry with information regarding the update is stored in a portion of memory (not shown) separate from the respective snapshot 102. For example, the entry can be stored in a memory overlay. The term “overlay” indicates a layering or stacking of changes on top of the existing dataset, providing a mechanism to keep the dataset up-to-date with the most recent changes while maintaining the integrity of the original data. An overlay, in this context, is a technique where changes or additions are superimposed onto the original dataset (e.g., snapshot 102), creating a modified view without altering the underlying dataset itself. This allows for a dynamic and instantaneous update of the data in memory without directly modifying the primary dataset (e.g., snapshot 102). In some embodiments, the portion of memory for storing the entry can be adjacent to the snapshot 102.

As discussed above, the update of the snapshot 102 by the snapshot generator 150 occurs asynchronously from the commitment of entries to the in-flight messages log 170 and the transmitting of those entries to the applications 130. Consequently, there is typically a time lag between a write 106 and the update of a snapshot 102, during which a read operation may take place. In some embodiments, while the records included in the entry are not compacted to the same extent as the snapshot 102, the records are available to be accessed in the event of an interim or transitional read operation occurring between the time of the write 106 and prior to the copies of the snapshot 102 being updated with the new records reflected in the published snapshot 108 by the snapshot generator 150. Accordingly, if a read operation associated with a record to be updated is performed prior to the snapshot generator 150 compacting the modified records into the snapshot 102, the memory overlay is accessed to respond to the read operation rather than accessing the snapshot 102 itself. In this way, RAW consistency is maintained because updated records are made available in the memory overlay upon receipt from the in-flight messages log 170 soon after a write operation 106.

In some embodiments, the snapshot generator 150 updates the snapshot 102 by compacting and incorporating the updated records into the published snapshot 108, which is then written to the dataset writer 140 and each of the applications 130. Once the snapshot 102 has been updated with the most recent updates, the snapshot 102 can be directly accessed for the updated records instead of the memory overlay. In some embodiments, the updated records are deleted from the memory overlay in the applications 130 subsequent to the records being incorporated into the snapshot 102. In this way, the overlay region of memory is freed up for new updates and the memory overhead for the in-flight records is reduced. In some embodiments, the dataset writer 140 also instructs the in-flight messages log 170 to delete all entries pertaining to the updated records, thereby making room in the in-flight message log 170 for new entries.

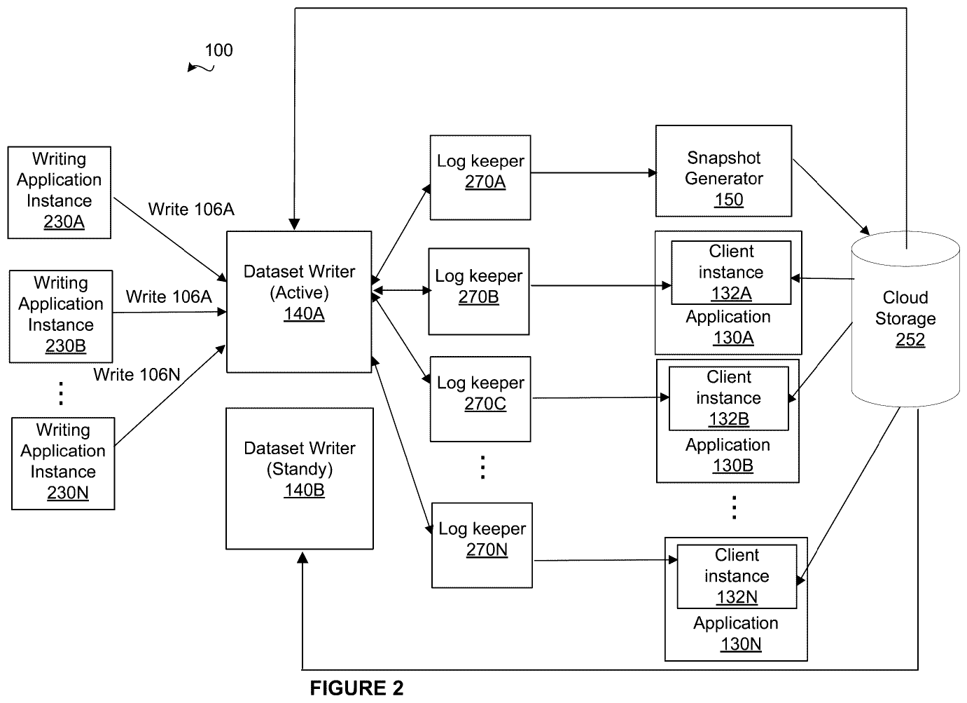

FIG. 2 is a more detailed illustration of the system 100 configured to implement one or more aspects of the various embodiments. As shown, in some embodiments, the system 100 includes, without limitation, applications 130 (e.g., including applications 130A, 130B, . . . 130N), a snapshot generator 150, a cloud storage 252, an active dataset writer 140A, a standby dataset writer 140B, writing application instances 230 (e.g., writing application instance 230A, writing application instance 230B, writing application instance 230N), and log keepers 270 (e.g., log keeper 270A, log keeper 270B, log keeper 270C, . . . log keeper 270N). In some embodiments, each of the applications 130 include, without limitation, a client instance 132 (e.g., client instance 132A included in application 130A, client instance 132B included in application 130B, . . . client instance 132N included in application 130N). In some other embodiments, the system 100 can include any number and/or types of other compute instances, other display devices, other databases, other data storage services, other services, other compute engines, other input devices, output devices, input/output devices, search engines, or any combination thereof. Note that the active dataset writer 140A and the standby dataset writer 140B perform substantially the same functions as the dataset writer 140 in FIG. 1. Furthermore, applications 130 perform substantially the same functions as the applications 130 in FIG. 1. Further, the log keepers 270, collectively, perform substantially the same functions as the in-flight messages log 170 of FIG. 1.

As noted in connection with FIG. 1, in some embodiments, a write 106 (e.g. write 106A, write 106B, . . . write 106N) is executed and transmitted to a dataset writer (e.g., active dataset writer 140A). As shown in FIG. 2, the write 106 can be executed by a writing application instance 230. The writing application instance 230, in some embodiments, can be incorporated within applications 130, where the applications 130 comprise both a client instance 132 that performs reads and a writing application instance 230 that performs writes. In other embodiments, the writing application instances 230 can be associated with applications that are independent of the applications 130 as shown in FIG. 2. As mentioned earlier, an application, including applications 130, can be dedicated solely to reads, exclusively engaged in writes, or involved in both reading and writing operations.

In some embodiments, the writing application instances 230 sends an update request (e.g., write 106). Records that are part of the snapshot 102 can be identified by primary keys and can be either added, deleted, updated or atomically conditionally updated. These updates are transmitted as part of write 106 to the dataset writer 140A using a format known as flat records. “Flat records” typically refers to a format where the data is stored in a simple, non-hierarchical structure, often as a list or array of values without nested relationships. It should be noted that during the operational state of the active dataset writer 140A, the writes 106 are directed to the active dataset writer 140A, while the standby dataset writer 140B remains in standby mode, ready to take over in the event of a failure in the active dataset writer 140A. In some embodiments, where there are multiple dataset writers 140 included in the system 100, an election scheme can be used to identify a leader that is used as the active dataset writer 140A.

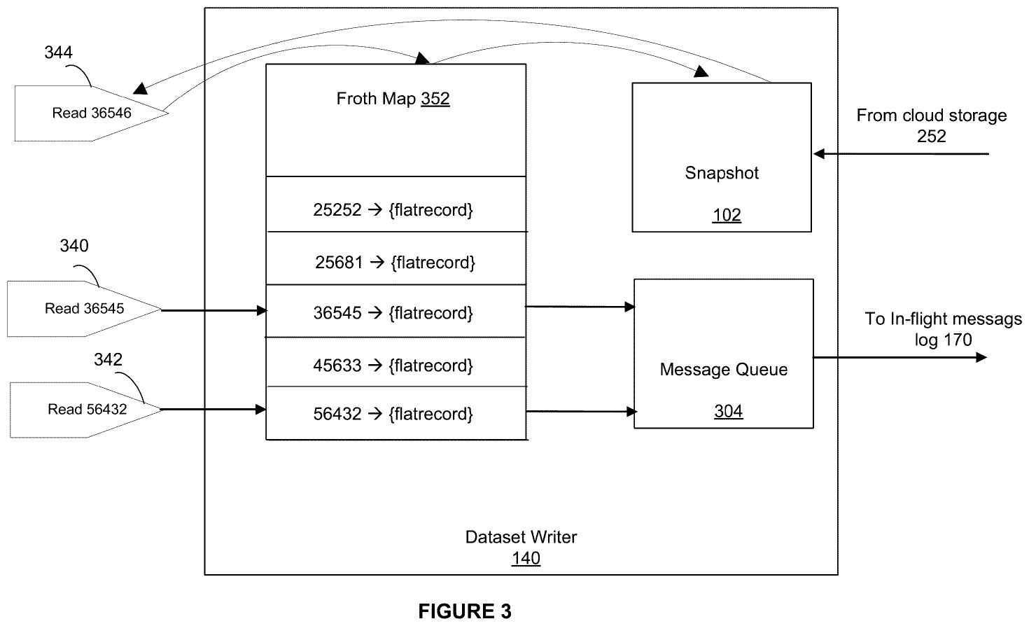

FIG. 3 is a more detailed illustration of the dataset writer 140 (e.g., active dataset writer 140A, standby dataset writer 140B, etc. as shown in FIG. 2) configured to implement one or more aspects of the various embodiments. As shown in FIG. 3, the dataset writer 140 includes, without limitation, a froth map 352, the dataset snapshot 102 and a message queue 304. The “froth map” comprises a hash table of in-flight updates made by one or more of the writing application instances 230 (shown in FIG. 2) that have not yet been compacted into the dataset snapshot 102. In some embodiments, the records within the froth map 352 are keyed by their primary key, which typically means that the entries in the froth map 352 are arranged or indexed based on the unique identifiers of the records, known as primary keys. Further, the information contained within these entries is represented in the form of flat records. In other words, the information within each entry in the froth map is structured in a flat format rather than a more complex or nested structure. This flat representation simplifies the handling of data during various processes within the system.

As shown in FIG. 3, read accesses (e.g., read operations 340 and 342) to the dataset writer 140 are directed to the froth map 352 to determine if the primary keys associated with the read match any of the primary keys in the froth map 352. For example, both the read operations 340 and 342 have matching primary keys (i.e., “36545” and “56432,” respectively) in the froth map 352 and, accordingly, any read accesses will be responded by using the entries in the froth map 352, which will be returned as flat records. Both the read operations 340 and 342 can, for example, be associated with records that are a product of one or more recent write operations where the results of the write operations are not yet reflected in the compacted snapshot 102. Read operation 344, on the other hand, may be associated with a record that has already been compacted into the snapshot 102. As a response to the read operation 344, the snapshot 102 is accessed in response to determining that the corresponding primary key “36546” is not present in the froth map 352. The record accessed from the snapshot 102 is encoded as a flat record and returned. As noted previously, the snapshot 102 is updated periodically by the snapshot generator 150 with the most recent records and the updated snapshot is received at the dataset writer 140 from the cloud storage 252, as shown in FIG. 2.

In some embodiments, newly generated writes (e.g., writes 106 as discussed in connection with FIG. 1) are directed to the appropriate entries within the froth map 352. Upon receiving a new write request, the dataset writer 140 creates a log entry describing the update and pushes the update message to a message queue 304. This message queue 304, in some embodiments, takes the form of a fixed-size double-ended queue (“deque”) specifically designated for pending log entries associated with in-flight messages slated for transmission to the in-flight message log 170, which comprises one or more log keepers 270, as shown in FIG. 2. Simultaneously, the log entry is assigned a sequentially incrementing offset value and an accompanying offset identifier.

Returning to FIG. 2, following the addition of the log entry to the message queue 304 and prior to committing any subsequent write requests, the active dataset writer 140A ensures the replication and commitment of the log entry to each of the log keepers 270 (including log keeper 270A communicatively coupled with the snapshot generator 150). In certain embodiments, each log keeper 270 responds with an acknowledgment upon receipt of the message, a prerequisite for considering the message as officially committed.

Subsequent to the commitment of the log entry to the log keepers 270, the entries within the froth map 352 are altered to incorporate the update. These modified entries are tagged with the offset identifier and value. Post-update integration into the froth map 352, the dataset writer 140A affirms the update request by responding to the original writing application instance 230. This response serves as confirmation of the successful processing of the update request initiated by the writing application 230.

In some embodiments, the snapshot generator 150 executes a repeating cycle during which it pulls the latest log entries from a log keeper 270 (e.g., log keeper 270A as shown in FIG. 2). Periodically (e.g., every 30 seconds), the snapshot generator 150 integrates the records associated with the latest log entries into the base snapshot 102. For instance, upon receiving the freshly committed log entry from the log keeper 270A, the snapshot generator 150 initiates the process of assimilating the log entry into the foundational dataset. As previously mentioned, the log entry is tagged with the offset identifier and value. In some embodiments, after incorporating the log entry with a current offset identifier into the snapshot 102, the snapshot generator 150 tags the snapshot 102 with the next log entry offset that the snapshot generator 150 expects to read.

In some embodiments, after incorporating a log entry into the snapshot 102, the snapshot generator 150 checks the next offset to be included from the log keeper 270A. If no new entries are found in the log keeper 270A, the snapshot generator 150 waits until the next cycle. If new entries are available, the snapshot generator retrieves entries from the log keeper 270A between the next offset discovered from the log keeper 270A and the currently committed offset, which is typically associated with the most recent committed entry. The snapshot generator 150 then begins to incorporate the retrieved entries into the base snapshot 102. In some embodiments, the snapshot generator 150 also tags the dataset writer 140A with the next offset to be included in the state produced in the next cycle, which typically holds a value one greater than the currently committed offset.

In some embodiments, the snapshot generator 150 also tags the dataset writer 140A with the offset that was already included in the snapshot 102, which indicates to the dataset writer 140A to drop log entries that are prior to this offset because these log entries have already been included in the snapshot 102. Accordingly, when a log entry linked to a particular offset identifier and value is merged into the base dataset of the snapshot 102, any entry in the froth map 352 of the dataset writer 140A (as shown in FIG. 3) marked with an offset preceding the specified offset is removed from the froth map 352, as those updates are now incorporated into the snapshot 102. By deleting records related to in-flight records that have already been incorporated into the snapshot 102, the froth map 352 is freed up to make room for new entries.

As illustrated in FIG. 2, both the active dataset writer 140A and the standby dataset writer 140B consistently receive the most current version of the snapshot 102 from cloud storage 252 because both the active dataset writer 140A and the standby dataset writer 140B maintain copies of the snapshot 102. This redundancy is crucial to the standby dataset writer 140B, ensuring the standby writer 140B possesses an updated copy for prompt takeover in the event of an active writer failure. Should the standby dataset writer 140B win the elections and assume active writer status, the standby writer 140B can efficiently retrieve all entries surpassing the latest record compressed into the snapshot 102 (identified by the offset identifier with which the snapshot 102 is tagged) from the log keepers 270. Subsequently, the standby dataset writer 140B constructs a froth map (resembling the froth map 352 in FIG. 3) using the retrieved entries and initializes a message queue (similar to the message queue 304 in FIG. 3) to connect with the log keepers 270. This strategic preparation enables a seamless transition of responsibilities in case of a shift from standby to active status.

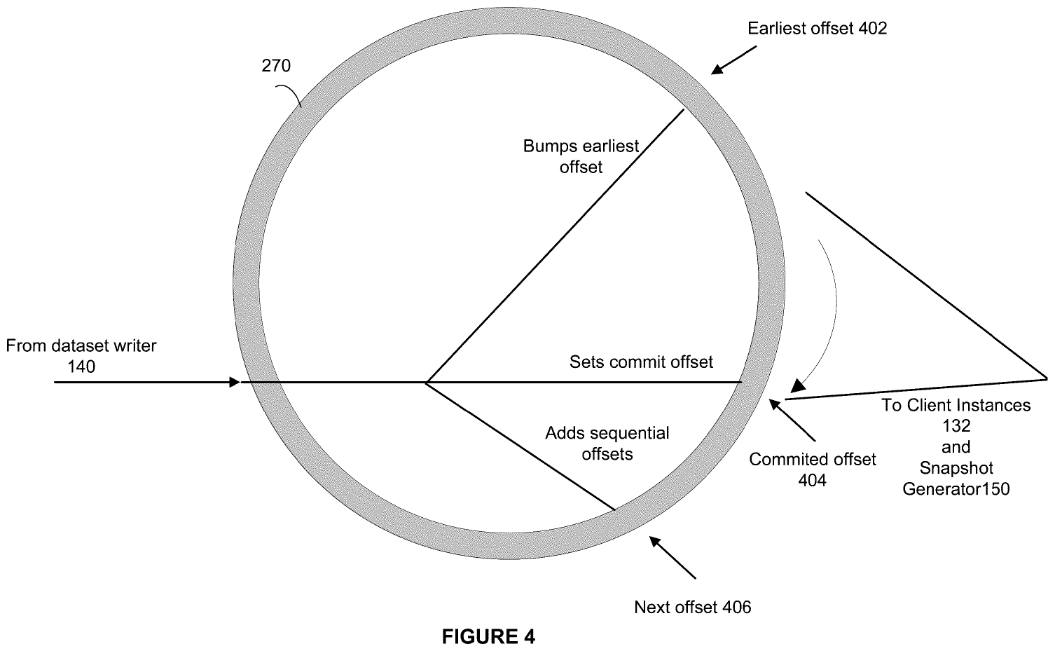

FIG. 4 is a more detailed illustration of a log keeper configured to implement one or more aspects of the various embodiments. In some embodiments, a log keeper 270 (e.g., log keeper 270A, log keeper 270B, . . . log keeper 270N) is implemented as a circular array of a finite size (e.g., 1 gigabyte or less) and holds in-flight log entries. In some embodiments, each log keeper 270 tracks three offsets: a) the earliest offset 402 currently retained; b) the committed offset 404 associated with the most recent committed entry, which typically holds a value of one more than the highest offset known to have been propagated to the set of log keepers 270; and c) the next offset 406 to be written.

In some embodiments, the dataset writer 140 (e.g., typically, the active dataset writer 140A) connects to the log keeper 270 using a Transmission Control Protocol (TCP) connection and transmits a message when new log entries are available. In some embodiments, TCP delivery and ordering guarantees ensure that messages sent from the writer 140 are delivered to the log keeper 270 in order and with fidelity. When a new log entry is available at the dataset writer 140, each message from the dataset writer 140 to the log keeper 270 comprises: a) the content of the new log entry and the associated offset; b) the offset associated with the currently committed log entry; and c) the offset of the earliest retained log entry. Upon receiving the message from the dataset writer 140, the log keeper 270 updates the internal state of the log keeper 270.

In some embodiments, the log keeper 270 will bump or increase the earliest offset 402 to reflect the offset of the earliest retained log entry received from the dataset writer 140. The log keeper 270 will also increase and set the committed offset 404 in accordance with the offset for the currently committed log entry received from the dataset writer 140. Further, the log keeper 270 will append any new entries and update the next offset 406 in accordance with the entries and offset received from the dataset writer. Because the log keeper 270 is a circular array, when the earliest offset 402 is increased in accordance with the message received from the dataset writer 140, the prior entries in the log do not need to be proactively deleted or cleared out from memory. The memory can simply be overwritten over time by newly available entries.

As shown in FIG. 2, each client instance 132 in an application 130 is communicatively coupled with a log keeper 270. When a client instance 132 (or snapshot generator 150) polls a log keeper 270 for new log entries, the client indicates the next offset that the client expects to receive (which typically holds a value of one greater than the last observed offset). When the offset specified by the client instance 132 is lower than the committed offset 404, as depicted in FIG. 4, the log keeper 270 replies with a consecutive series of messages spanning from the client instance's indicated offset to the committed offset 404. In the event that the indicated offset from the client instance 132 aligns with the committed offset 404, the log keeper 270 temporarily holds the polling request, responding with no new updates during a specified timeframe. If, within this timeframe, no fresh entries are received from the dataset writer 140, the log keeper 270 maintains its response of no new updates. However, if the dataset writer 140 transmits a new commit offset along with corresponding entries during this period, the log keeper 270 then replies with the sequential set of messages spanning from the previous commit offset to the new commit offset received from the dataset writer 140.

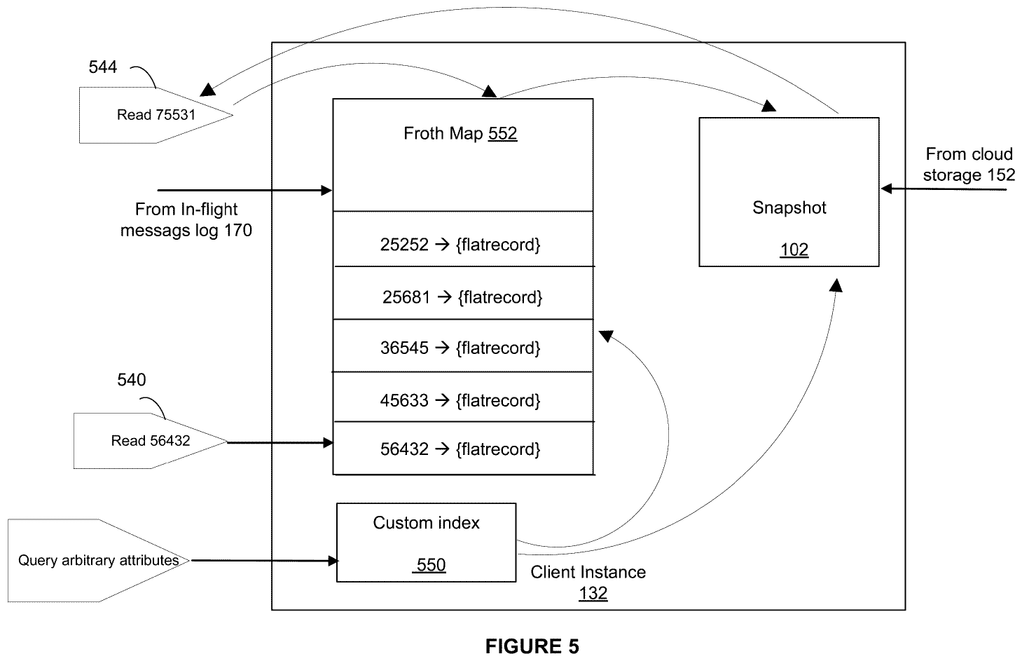

FIG. 5 is a more detailed illustration of client instance 132 (e.g., client instance 132A as shown in FIG. 2) configured to implement one or more aspects of the various embodiments. As shown in FIG. 4, the client instance 132 includes, without limitation, a froth map 552, the dataset snapshot 102 and custom index 550. In some embodiments, the froth map 552 comprises a hash table of in-flight updates received from the in-flight messages log 170, where the in-flight updates have not yet been incorporated into snapshot 102. The froth map 552 operates substantially similarly to the froth map 352 discussed in connection with FIG. 3 and comprises the memory overlay discussed in connection with FIG. 1 that is used to store updates to records (received from the in-flight messages log 170) that are not yet fully incorporated into the snapshot 102.

Similar to the froth map 352 of FIG. 3, in some embodiments, the records within the froth map 552 are keyed by their primary key, which typically means that the entries in the froth map 552 are arranged or indexed based on the unique identifiers of the records, known as primary keys. Further, the information contained within these entries is represented in the form of flat records. This flat representation simplifies the handling of data during various processes within the system.

As shown in FIG. 5, read accesses (e.g., read operation 540) to the client instance 132, which include local reads 104 (as discussed in connection with FIG. 1), are directed to the froth map 552 to determine if the primary keys associated with the read access match any of the primary keys in the froth map 552. For example, the read operation 540 has a matching primary key (i.e., “56432”) in the froth map 552 and, accordingly, any read access will be responded by using the entries in the froth map 552, which will be returned as flat records. Read operation 544, on the other hand, may be associated with a record that has already been compacted into the snapshot 102. As a response to the read operation 544, the client instance 132 accesses the snapshot 102 after it is determined that the corresponding primary key “75531” is not present in the froth map 552. The record accessed from the snapshot 102 is encoded as a flat record and returned. As noted previously, the snapshot 102 is updated periodically by the snapshot generator 150 with the most recent records and the updated snapshot is received at the application 130 (and the client instance 132 included therein) from the cloud storage 252, as shown in FIG. 2.

As discussed above, in some embodiments, the client instance 132 autonomously initiates periodic polls to the log keepers 270 at consistent intervals. In some instances, these intervals are sufficiently brief, almost approaching continuous polling. In some embodiments, the polling can be continuous. When new data is available, the poll returns the new entries as soon as the entries are available. When a poll returns new entries, the new entries are incorporated atomically into the froth map 552 and the indexes associated with the froth map 552 (including the custom index 550) are updated accordingly. The froth map 552 can be used to respond to queries associated with records that have not yet been updated and incorporated into the snapshot 102. It is worth highlighting that although the records in the froth map 552 may not undergo the same degree of compaction as those in the snapshot 102, the memory footprint of the froth map 552 remains relatively modest. This is attributed to the periodic integration by the snapshot generator 150, wherein entries from the froth map are systematically incorporated into the snapshot 102. As a result, entries are systematically removed from the froth map 552, ensuring that the size of the froth map 552 remains manageable and constrained.

In some embodiments, the client instance 132 exhibits behavior similar to the dataset writer 140 when receiving an update to the base snapshot 102. Entries within the froth map 552 labeled with an offset preceding the offset identifier associated with the snapshot 102 (tagged to the most recent generated snapshot 102 by the snapshot generator 150) are removed, as these updates are now integrated into the base snapshot 102.

In some embodiments, each client instance 132 includes a custom index 550 that is particular to a client instance 132. The custom index 550 enables indexing for arbitrary values to the dataset (including the froth map 552 and the snapshot 102), which can be defined differently for each client instance 142 depending on access needs.

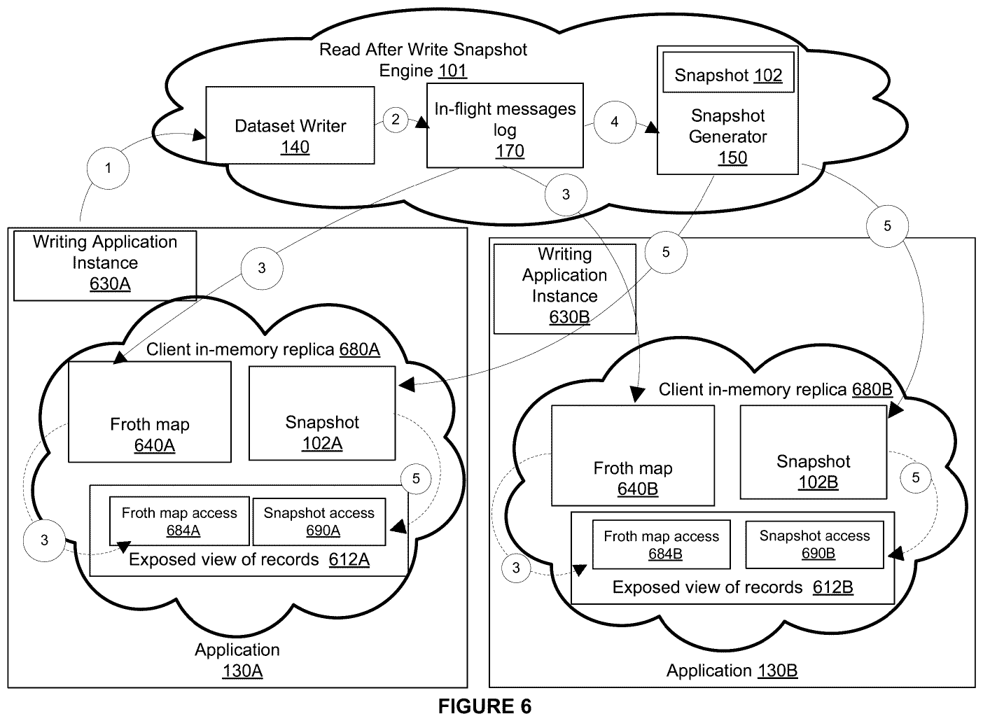

FIG. 6 is an illustration of the manner in which the RAW snapshot engine maintains RAW consistency in a distributed architecture, according to one or more aspects of the various embodiments. As shown in FIG. 6, a RAW snapshot engine 101 comprises a dataset writer 140, an in-flight messages log 170 and a snapshot generator 150. The in-flight messages log 170 comprises one or more log keepers, as discussed in connection with FIG. 2. The snapshot generator 150 periodically updates and generates a new snapshot 102 at periodic intervals. Each element within the RAW snapshot engine 101 carries out functions that are essentially identical to the corresponding components outlined in relation to FIGS. 1 and 2. Applications 130 (e.g., applications 130A and 130B) also perform substantially the same functions as corresponding components outlined in relation to FIGS. 1 and 2.

In some embodiments, applications 130 can perform both read and write operations. The write operations can be performed by a writing application instance 630 (e.g., writing application instance 630A in application 130A and writing application instance 630B in application 130B), which performs substantially the same functions as writing application instances 230 in FIG. 2. FIG. 6 further illustrates a client in-memory replica 680 (e.g., client in-memory replica 680A, client in-memory replica 680B) for each of the applications 130. Each client in-memory replica 680 is a memory representation of a client instance (not shown in FIG. 6) included in a respective application 130. Each client in-memory replica 680 illustrates a froth map 640 (e.g., froth map 640A, froth map 640B), a snapshot (e.g., snapshot 102A, snapshot 102B), and an exposed view of records 612 (e.g., exposed view of records 612A, exposed view of records 612B). The exposed view of records 612 illustrates the temporal accessibility of a specific record in response to a read operation, either through froth map access (e.g., froth map access 684A, froth map access 684B) or snapshot access (e.g. snapshot access 690A, snapshot access 690B).

At bubble 1, a writing application instance 630A associated with the application 130A performs a write that updates one or more records in a dataset snapshot 102 and the write is transmitted to the dataset writer 140. When writing application instance 630A attempts to perform an update or a write, this update is initially not visible to the application 130B. When a write occurs, however, it is essential for the updated record to be promptly reflected across the snapshots 102 (e.g., snapshot 102A and snapshot 102B) at each of the applications 130, ensuring consistency for subsequent reads.

Upon receipt, at bubble 2, the dataset writer 140 creates an entry in an in-flight messages log 170. The in-flight messages log 170 comprises one or more circular arrays (also known as log keepers) for tracking in-flight updates that have not yet been reflected in the dataset snapshot 102 but that need to be accounted for when responding to read requests associated with the snapshot 102.

Immediately after recording the new entry in the in-flight message log 170, at bubble 3, the in-flight messages log 170 forwards the updates to any listening applications 130. As shown in FIG. 6, at bubble 3, the log keepers included in the in-flight messages log 170 forward the updates to applications 130A and 130B. In application 130A, the log entries reflecting the updates are incorporated into froth map 640A. Similarly, in application 130B, the log entries reflecting the updates are incorporated into froth map 640B.

At bubble 4, the log entries are also sent to the snapshot generator 150. As previously noted, the snapshot generator 150 can asynchronously poll the in-flight messages log 170 at periodic intervals independent of the transmissions of entries to the applications 130.

In some embodiments, as mentioned above, at bubble 5, the snapshot generator 150 periodically updates the snapshot 102 at set intervals (e.g., every 30 seconds), and these refreshed snapshots are distributed to the applications 130. The refreshed snapshots from the snapshot generator 150 replace the existing snapshots 102 in the applications. Thereafter, the snapshots 102A and 102B within applications 130A and 130B, respectively, can be accessed for information pertaining to the updated records.

For the time duration between bubble 3 and bubble 5, however, the exposed view of records 612 relies on the froth map access 684 to provide information pertaining to the updated records. After bubble 5, however, the exposed view of records 612 relies on the snapshot access 690 to provide information pertaining to the updated records because following bubble 5, the updates are incorporated into the snapshot 102. Because the in-flight messages log 170 updates the froth maps 640A and 640B simultaneously (or substantially simultaneously) after bubble 3, any read access to either of the two applications attempting to access the updated entry will provide the same result. Similarly, because the snapshot generator 150 updates the snapshot 102 for both applications simultaneously (or substantially simultaneously), both applications would provide the same result to a read access after the updated records have been incorporated into the snapshot 102.

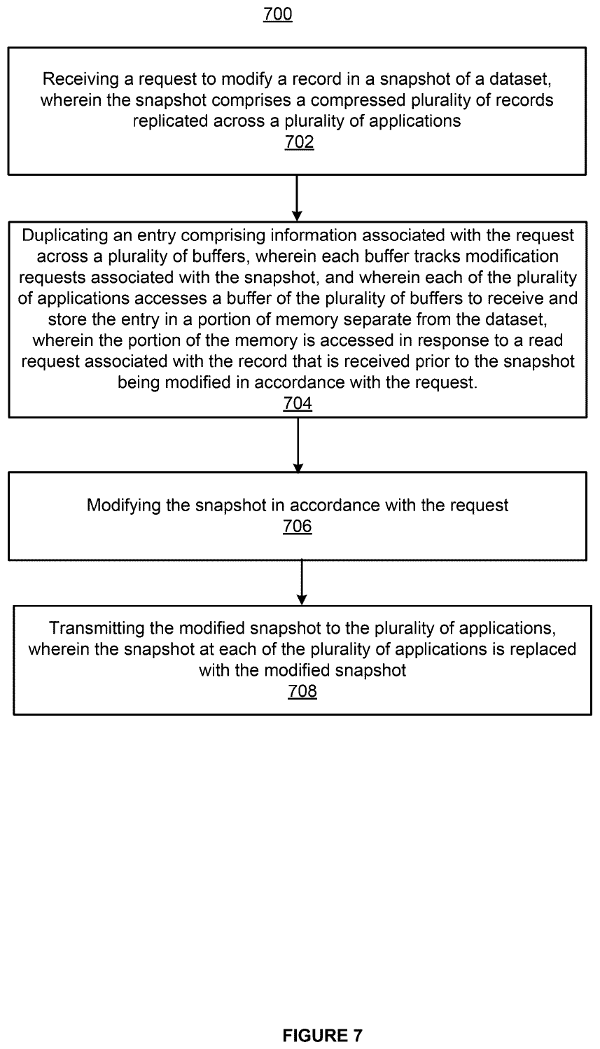

FIG. 7 is a flow diagram of method steps for modifying snapshots of datasets distributed over a network, according to one or more aspects of the various embodiments. Although the method steps are described with reference to the systems of FIGS. 1-6, persons skilled in the art will understand that any system configured to implement the method steps, in any order, falls within the scope of the present invention

As shown, a method 700 begins at step 702, where a request to modify a record in a snapshot of a dataset is received. For example, as discussed in connection with FIGS. 1 and 2, a write 106A can be received at the active dataset writer 140A from a writing application instance 230. The snapshot 102 of the dataset comprises a compressed plurality of records replicated across a plurality of applications 130.

At step 704, an entry comprising information associated with the request to modify is replicated across a plurality of buffers. For example, each buffer can be a circular array referred to herein as a log keeper. The write 106A can, for example, be duplicated across one or more log keepers 270 as shown in FIG. 2. Each log keeper 270 tracks modification requests associated with the snapshot 102. Each client instance 132 in an application 130 accesses a log keeper 270 to receive and store the entry in a portion of memory separate from the dataset (e.g., an overlay memory that can comprise a froth map 552 as discussed in connection with FIG. 5). As discussed in connection with FIG. 5, the portion of the memory (e.g., the froth map 552) is accessed in response to a read request (e.g., read operation 540) associated with the record that is received prior to the snapshot 102 being modified in accordance with the request. The froth map 552 comprises records that correspond to write requests and updates that have not yet been incorporated into the snapshot 102. Accordingly, any read requests associated with those records are responded to using the froth map 552 until the snapshot generator 150 incorporates those records into the snapshot 102.

At step 706, the snapshot generator 150 modifies the snapshot 102 in accordance with the request. The snapshot generator 150 periodically (e.g., every 30 seconds) receives information from a log keeper (e.g., log keeper 270A in FIG. 2) and incorporates any new entries received from the log keeper into the snapshot 102.

At step 708, the modified snapshot (e.g., the published snapshot 108 in FIG. 1) is disseminated to the applications 130, where the existing snapshot 102 is replaced with the modified snapshot. As discussed in connection with FIG. 1, the published snapshot 108 transmitted from the snapshot generator 150 replaces the snapshot at each of the applications 130.

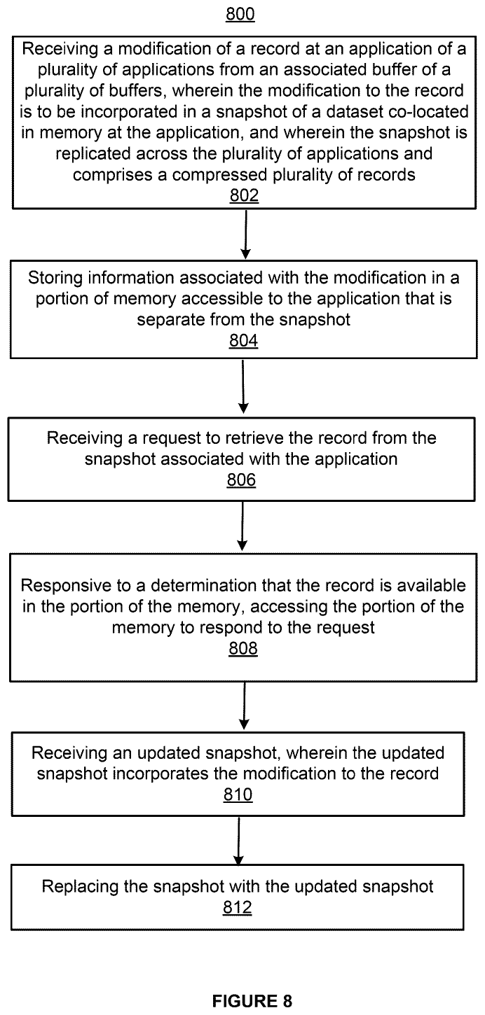

FIG. 8 is a flow diagram of method steps for reading snapshots of datasets distributed over a network, according to one or more aspects of the various embodiments. Although the method steps are described with reference to the systems of FIGS. 1-6, persons skilled in the art will understand that any system configured to implement the method steps, in any order, falls within the scope of the present invention.

As shown, a method 800 begins at step 802, where a modification of a record is received at an application of a plurality of applications from an associated buffer of a plurality of buffers. For example, as discussed in connection with FIGS. 1 and 2, a write 106A is replicated by a dataset writer 140A to the log keepers 270. The client instances 132 poll the log keepers 270 to receive new entries that comprise information regarding the records to be modified. The modification to the records is to be incorporated into the snapshot 102, which comprises a compressed set of records, by a snapshot generator 150. The snapshot 102 is replicated across the applications 130, where each application 130 has a copy of the snapshot 102 co-located in memory.

At step 804, information associated with the record modification is stored in a portion of memory accessible to the application that is separate from the snapshot. As discussed in connection with FIG. 5, the froth map 552 stores entries associated with any updates (e.g., adding, modifying, deleting or conditionally updating a record). The froth map 552 stores in-flight records that have not yet been incorporated into the snapshot 102.

At step 806, a request (e.g., a read request 540) is received to retrieve the record from the snapshot co-located in memory with the associated application. For example, a client instance 132 can perform a read access to read a particular record from the snapshot 102.

At step 808, responsive to a determination that the record is available in the portion of memory, the portion of memory is accessed to respond to the request. As shown in FIG. 5, prior to accessing the snapshot 102 for the record, the froth map 552 is read to determine if there are any matching entries in the froth map 552. Responsive to a determination that a matching entry for the record is found in the froth map 552, the record is accessed from the froth map 552.

At step 810, an updated snapshot is received wherein the updated snapshot incorporates the modifications to the record. As discussed in connection with FIGS. 1 and 2, the snapshot generator 150 generates updated snapshots (e.g., published snapshots 108) that replace the snapshots 102 that are replicated across the distributed architecture.

At step 812, the snapshot 102 co-located in memory with each of the applications 130 is substituted with the updated snapshot (e.g., the published snapshot 108). As discussed above, once the updates to the record are incorporated into the snapshot 102, any entries in the froth map 552 associated with the modifications that have been incorporated into the snapshot 102 can be deleted from the froth map 552.

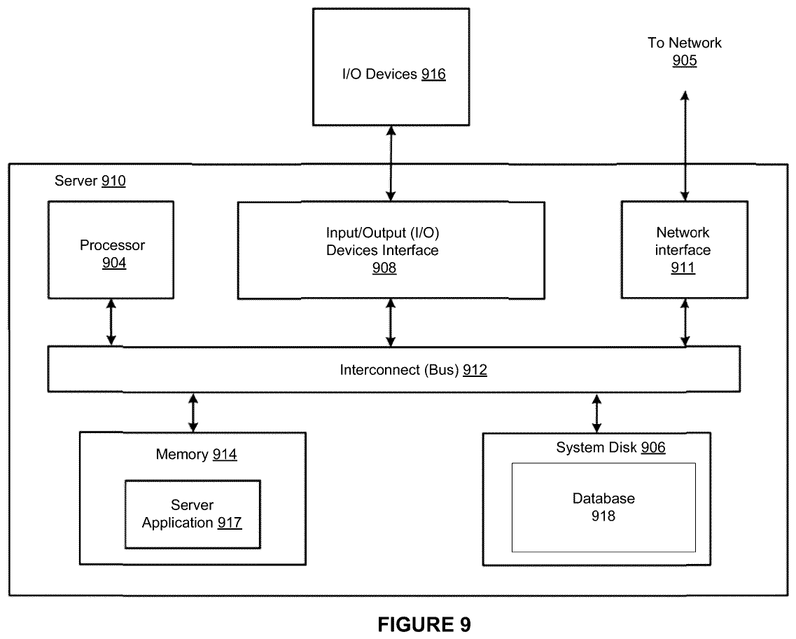

FIG. 9 is a block diagram of a server 910 that may be implemented in conjunction with system 100 of FIG. 1, according to various embodiments of the present invention. The RAW snapshot engine 101 and the applications 130 can be implemented on or across one or more of the servers 910 shown in FIG. 9. As shown, the server 910 includes, without limitation, a processor 904, a system disk 906, an input/output (I/O) devices interface 908, a network interface 911, an interconnect 912, and a system memory 914.

The processor 904 is configured to retrieve and execute programming instructions, such as server application 917, stored in the system memory 914. The processor 904 may be, without limitation, general purpose processors, special-purpose processors, application-specific processors, or field-programmable gate arrays.

The processor 904 can, in some embodiments, be configured to execute the RAW snapshot engine 101 discussed in connection with FIG. 1. Similarly, the processor 904 can also be configured to execute one more applications 130 discussed in connection with FIG. 1. The interconnect 912 is configured to facilitate transmission of data, such as programming instructions and application data, between the CPU 904, the system disk 906, I/O devices interface 908, the network interface 911, and the system memory 914. The I/O devices interface 908 is configured to receive input data from I/O devices 916 and transmit the input data to the processor 904 via the interconnect 912. For example, I/O devices 916 may include one or more buttons, a keyboard, a mouse, and/or other input devices. The I/O devices interface 908 is further configured to receive output data from the processor 904 via the interconnect 912 and transmit the output data to the I/O devices 916.

The system disk 906 may include one or more hard disk drives, solid state storage devices, or similar storage devices. The system disk 906 is configured to store a database 918 of information (e.g., the system disk 906 can store a non-volatile copy of the entity index that is loaded into the memory 914 on system startup). In some embodiments, the network interface 911 is configured to operate in compliance with the Ethernet standard.

The system memory 914 includes a server application 917. For example, the server application 917, in some embodiments, can store the RAW snapshot engine 101. In some embodiments, the server application 917 can store the snapshot 102 in memory that is co-located with the server application 917. Also, the server application 917 can store one or more applications 130. For explanatory purposes only, each server application 917 is described as residing in the memory 914 and executing on the processor 904. In some embodiments, any number of instances of any number of software applications can reside in the memory 914 and any number of other memories associated with any number of compute instances and execute on the processor 904 and any number of other processors associated with any number of other compute instances in any combination. In the same or other embodiments, the functionality of any number of software applications can be distributed across any number of other software applications that reside in the memory 914 and any number of other memories associated with any number of other compute instances and execute on the processor 910 and any number of other processors associated with any number of other compute instances in any combination. Further, subsets of the functionality of multiple software applications can be consolidated into a single software application.

In sum, the disclosed techniques may be used for modifying snapshots of datasets distributed over a network. The method includes receiving a request to modify a record in a snapshot of a dataset, wherein the snapshot comprises a compressed plurality of records replicated across a plurality of applications, and wherein the snapshot is co-located in memory associated with each respective application. The method further includes duplicating an entry comprising information associated with the request across a plurality of buffers, wherein each buffer tracks modification requests associated with the snapshot, and wherein each of the plurality of applications accesses a buffer of the plurality of buffers to receive and store the entry in a portion of memory separate from the dataset, wherein the portion of the memory is accessed in response to a read request associated with the record that is received prior to the snapshot being modified in accordance with the request. The method also comprises modifying the snapshot in accordance with the request and transmitting the modified snapshot to the plurality of applications, wherein the snapshot at each of the plurality of applications is replaced with the modified snapshot.

The disclosed techniques can also be used for reading datasets distributed over a network. The method includes receiving a modification of a record at an application of a plurality of applications from an associated buffer of a plurality of buffers, wherein the modification to the record is to be incorporated in a snapshot of a dataset co-located in memory at the application, and wherein the snapshot is replicated across the plurality of applications and comprises a compressed plurality of records. The method further comprises storing information associated with the modification in a portion of memory accessible to the application that is separate from the snapshot. The method also comprises receiving a request to retrieve the record from the snapshot associated with the application. Responsive to a determination that the record is available in the portion of the memory, the method comprises accessing the portion of the memory to respond to the request. Further, the method comprises receiving an updated snapshot, wherein the updated snapshot incorporates the modification to the record, and replacing the snapshot with the updated snapshot.

At least one technical advantage of the disclosed techniques relative to the prior art is that, the disclosed techniques effectively maintain Read-After-Write (RAW) consistency across multiple datasets or snapshots of datasets distributed across several applications or a distributed platform. By ensuring RAW consistency, the disclosed techniques ensure that any update to a snapshot of a dataset, regardless of the application that initiates the update, is immediately reflected in all distributed copies. This consistency is important for applications relying on synchronized, real-time data. Moreover, the utilization of compressed sets of records co-located in memory at each application enhances performance by reducing data retrieval latency. The distributed nature of the system facilitates scalability and fault tolerance, allowing seamless operations even in the face of node failures. The disclosed techniques not only foster a unified and up-to-date view of the data across diverse applications but also streamline development processes by providing a consistent and reliable foundation for data operations, ultimately improving the overall efficiency and reliability of the distributed ecosystem.

Utilizing the disclosed techniques to replace persistent storage by co-locating datasets (or snapshots of datasets) in memory across a distributed architecture offers a range of other compelling advantages. One of the primary advantages is the boost in data access speed. Retrieving information directly from memory is significantly faster than fetching it from traditional disk-based storage, thereby enhancing overall system performance. Additionally, in-memory co-location eliminates the need for disk I/O operations, reducing latency and accelerating data access for critical applications. Furthermore, by storing datasets in RAM, the disclosed techniques minimize the impact of I/O bottlenecks, ensuring that applications experience smoother and more responsive operations. Additionally, the shift to in-memory storage often leads to more efficient resource utilization. RAM offers quicker access times compared to traditional storage media, allowing for rapid data retrieval and processing. This efficiency translates into improved scalability, enabling the system to effortlessly handle growing datasets and increasing workloads. Moreover, the reduced reliance on persistent storage can contribute to cost savings, as organizations may require less investment in high-capacity disk storage solutions.

1. In some embodiments, a computer-implemented method for modifying snapshots of datasets distributed over a network comprises receiving a request to modify a record in a snapshot of a dataset, wherein the snapshot comprises a compressed plurality of records replicated across a plurality of applications, and wherein the snapshot is co-located in memory associated with each application, duplicating an entry comprising information associated with the request across a plurality of buffers, wherein each buffer tracks modification requests associated with the snapshot, and wherein each of the plurality of applications accesses a buffer of the plurality of buffers to receive and store the entry in a portion of memory separate from the dataset, wherein the portion of the memory is accessed in response to a read request associated with the record that is received prior to the snapshot being modified in accordance with the request, modifying the snapshot in accordance with the request, and transmitting the modified snapshot to the plurality of applications, wherein the snapshot at each of the plurality of applications is replaced with the modified snapshot.

2. The computer-implemented method of clause 1, wherein the dataset comprises metadata describing one or more characteristics of video content.

3. The computer-implemented method of clauses 1 or 2, wherein the request to modify the record includes at least one of adding, modifying, deleting or conditionally updating the record.

4. The computer-implemented method of any of clauses 1-3, wherein the portion of memory comprises a hash table of updates to records in the snapshot that have not been reflected in the plurality of records included in the snapshot.

5. The computer-implemented method of any of clauses 1-4, wherein the hash table is indexed based on unique identifiers of records in the hash table.

6. The computer-implemented method of any of clauses 1-5, further comprising prior to transmitting the modified snapshot, tagging the modified snapshot with an offset value indicating that the record associated with the entry has been updated in the snapshot.

7. The computer-implemented method of any of clauses 1-6, wherein the request to modify the record is received as a flat record.

8. The computer-implemented method of any of clauses 1-7, further comprising prior to transmitting the modified snapshot, tagging the modified snapshot with an offset value indicating that the record associated with the entry has been updated in the snapshot, wherein the offset value is used by the plurality of applications to determine that the entry in the portion of memory should be deleted.

9. The computer-implemented method of any of clauses 1-8, wherein modifying the snapshot and transmitting the modified snapshot to the plurality of applications is performed over periodic intervals.

10. The computer-implemented method of any of clauses 1-9, wherein duplicating the entry comprises creating a log entry associated with the request, pushing the log entry to a message queue, duplicating the entry across the plurality of buffers, waiting for an acknowledgment from each of the plurality of buffers, and responsive to an acknowledgment from each of the plurality of buffers, designating the log entry as committed.

11. The computer-implemented method of any of clauses 1-10, wherein the message queue comprises a fixed-size double-ended queue.

12. The computer-implemented method of any of clauses 1-11, wherein each of the plurality of buffers comprises a circular array of fixed size.

13. The computer-implemented method of any of clauses 1-12, wherein the plurality of applications is associated with a content streaming platform.

14. In some embodiments, a non-transitory computer-readable storage medium includes instructions that, when executed by a processor, cause the processor to perform the steps of receiving a request to modify a record in a snapshot of a dataset, wherein the snapshot comprises a compressed plurality of records replicated across a plurality of applications, and wherein the snapshot is co-located in memory associated with each application, duplicating an entry comprises information associated with the request across a plurality of buffers, wherein each buffer tracks modification requests associated with the snapshot, and wherein each of the plurality of applications accesses a buffer of the plurality of buffers to receive and store the entry in a portion of memory separate from the dataset, wherein the portion of the memory is accessed in response to a read request associated with the record that is received prior to the snapshot being modified in accordance with the request, modifying the snapshot in accordance with the request, and transmitting the modified snapshot to the plurality of applications, wherein the snapshot at each of the plurality of applications is replaced with the modified snapshot.

15. The non-transitory computer readable media of clause 14, wherein the plurality of applications are associated with a content streaming platform.

16. The non-transitory computer readable media of clauses 14 or 15, wherein the dataset comprises metadata describing various characteristics of videos.

17. The non-transitory computer readable media of any of clauses 14-16, wherein the request to modify the record includes at least one of adding, modifying, deleting or conditionally updating the record.

18. The non-transitory computer readable media of any of clauses 14-17, wherein the portion of memory comprises a hash table of updates to records in the snapshot that have not been reflected in the plurality of records included in the snapshot.

19. In some embodiments, a system comprises a memory storing an application associated with a read-after-write snapshot engine, and a processor coupled to the memory, wherein when executed by the processor, the read-after-write snapshot engine causes the processor to receive a request to modify a record in a snapshot of a dataset, wherein the snapshot comprises a compressed plurality of records replicated across a plurality of applications, and wherein the snapshot is co-located in memory associated with each application, duplicate an entry comprising information associated with the request across a plurality of buffers, wherein each buffer tracks modification requests associated with the snapshot, and wherein each of the plurality of applications accesses a buffer of the plurality of buffers to receive and store the entry in a portion of memory separate from the dataset, wherein the portion of the memory is accessed in response to a read request associated with the record that is received prior to the snapshot being modified in accordance with the request, modify the snapshot in accordance with the request, and transmit the modified snapshot to the plurality of applications, wherein the snapshot at each of the plurality of applications is replaced with the modified snapshot.

20. The system of clause 19, wherein each of the plurality of buffers comprises a circular array of fixed size.

21. In some embodiments, a method for reading datasets distributed over a network comprises receiving a modification of a record at an application of a plurality of applications from an associated buffer of a plurality of buffers, wherein the modification to the record is to be incorporated in a snapshot of a dataset co-located in memory at the application, and wherein the snapshot is replicated across the plurality of applications and comprises a compressed plurality of records, storing information associated with the modification in a portion of memory accessible to the application that is separate from the snapshot, receiving a request to retrieve the record from the snapshot associated with the application, responsive to a determination that the record is available in the portion of memory, accessing the portion of the memory to respond to the request, receiving an updated snapshot, wherein the updated snapshot incorporates the modification to the record, and replacing the snapshot with the updated snapshot.

22. The computer-implemented method of clause 21, wherein the dataset comprises metadata describing various characteristics of videos.

23. The computer-implemented method of clauses 21 or 22, wherein the modification of the record includes at least one of adding, modifying, deleting or conditionally updating the record.

24. The computer-implemented method of any of clauses 21-23, wherein the portion of memory comprises a hash table of updates to records in the snapshot that have not been reflected in the plurality of records included in the snapshot.

25. The computer-implemented method of any of clauses 21-24, wherein the hash table is indexed based on unique identifiers of records in the hash table.

26. The computer-implemented method of any of clauses 21-25, wherein the portion of memory is accessed prior to accessing the snapshot co-located in memory with the application.

27. The computer-implemented method of any of clauses 21-26, wherein each of the plurality of buffers comprises a circular array of fixed size.

28. The computer-implemented method of any of clauses 21-27, wherein each of the plurality of buffers comprises a circular array of fixed size, and wherein each buffer of the plurality of buffers uses offset values to track modification requests that have not been transmitted to the plurality of applications.

29. The computer-implemented method of any of clauses 21-28, wherein the plurality of applications is associated with a content streaming platform.

30. The computer-implemented method of any of clauses 21-29, further comprising determining a tag associated with the updated snapshot, wherein the updated snapshot is tagged with an offset value indicating that the record associated with the entry has been incorporated into the updated snapshot, and removing the record from the portion of memory.

31. The computer-implemented method of any of clauses 21-30, wherein receiving the updated snapshot and replacing the snapshot is performed at periodic intervals.

32. In some embodiments, a non-transitory computer-readable storage medium includes instructions that, when executed by a processor, cause the processor to perform the steps of receiving a modification of a record at an application of a plurality of applications from an associated buffer of a plurality of buffers, wherein the modification to the record is to be incorporated in a snapshot of a dataset co-located in memory at the application, and wherein the snapshot is replicated across the plurality of applications and comprises a compressed plurality of records, storing information associated with the modification in a portion of memory accessible to the application that is separate from the snapshot, receiving a request to retrieve the record from the snapshot associated with the application, responsive to a determination that the record is available in the portion of memory, accessing the portion of the memory to respond to the request, receiving an updated snapshot, wherein the updated snapshot incorporates the modification to the record, and replacing the snapshot with the updated snapshot.

33. The non-transitory computer readable media of clause 32, wherein the plurality of applications are associated with a content streaming platform.

34. The non-transitory computer readable media of clauses 32 or 33, wherein the dataset comprises metadata describing various characteristics of videos.

35. The non-transitory computer readable media of any of clauses 32-34, wherein the modification of the record includes at least one of adding, modifying, deleting or conditionally updating the record.

36. The non-transitory computer readable media of any of clauses 32-35, wherein the portion of memory comprises a hash table of updates to records in the snapshot that have not been reflected in the plurality of records included in the snapshot.

37. The non-transitory computer readable media of any of clauses 32-36, wherein each of the plurality of buffers comprises a circular array of fixed size, and wherein each buffer of the plurality of buffers uses offset values to track modification requests that have not been transmitted to the plurality of applications.

38. In some embodiments, a system comprises a memory storing an application associated with a client instance, and a processor coupled to the memory, wherein when executed by the processor, the client instance causes the processor to receive a modification of a record at the client instance of an application of a plurality of applications from an associated buffer of a plurality of buffers, wherein the modification to the record is to be incorporated in a snapshot of a dataset co-located in memory at the application, and wherein the snapshot is replicated across the plurality of applications and comprises a compressed plurality of records, store information associated with the modification in a portion of memory accessible to the application that is separate from the snapshot, receive a request to retrieve the record from the snapshot associated with the application, responsive to a determination that the record is available in the portion of memory, access the portion of the memory to respond to the request, receive an updated snapshot, wherein the updated snapshot incorporates the modification to the record, and replace the snapshot with the updated snapshot.

39. The system of clause 38, wherein the portion of memory comprises a hash table of updates to records in the snapshot that have not been reflected in the plurality of records included in the snapshot.

40. The system of clauses 38 or 39, wherein the hash table is indexed based on unique identifiers of records in the hash table.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for modifying snapshots of datasets distributed over a network, comprising:
receiving a request to modify a record in a snapshot of a dataset, wherein the snapshot comprises a compressed plurality of records replicated across a plurality of applications, and wherein the snapshot is co-located in memory associated with each application;
duplicating an entry comprising information associated with the request across a plurality of buffers, wherein each buffer tracks modification requests associated with the snapshot, and wherein each of the plurality of applications accesses a buffer of the plurality of buffers to receive and store the entry in a portion of memory separate from the dataset, wherein the portion of the memory is accessed in response to a read request associated with the record that is received prior to the snapshot being modified in accordance with the request;
modifying the snapshot in accordance with the request; and
transmitting the modified snapshot to the plurality of applications, wherein the snapshot at each of the plurality of applications is replaced with the modified snapshot.

2. The computer-implemented method of claim 1, wherein the dataset comprises metadata describing one or more characteristics of video content.

3. The computer-implemented method of claim 1, wherein the request to modify the record includes at least one of adding, modifying, deleting or conditionally updating the record.

4. The computer-implemented method of claim 1, wherein the portion of memory comprises a hash table of updates to records in the snapshot that have not been reflected in the plurality of records included in the snapshot.

5. The computer-implemented method of claim 4, wherein the hash table is indexed based on unique identifiers of records in the hash table.

6. The computer-implemented method of claim 1, further comprising:
prior to transmitting the modified snapshot, tagging the modified snapshot with an offset value indicating that the record associated with the entry has been updated in the snapshot.

7. The computer-implemented method of claim 1, wherein the request to modify the record is received as a flat record.

8. The computer-implemented method of claim 1, further comprising:
prior to transmitting the modified snapshot, tagging the modified snapshot with an offset value indicating that the record associated with the entry has been updated in the snapshot, wherein the offset value is used by the plurality of applications to determine that the entry in the portion of memory should be deleted.

9. The computer-implemented method of claim 1, wherein modifying the snapshot and transmitting the modified snapshot to the plurality of applications is performed over periodic intervals.

10. The computer-implemented method of claim 1, wherein duplicating the entry comprises:
creating a log entry associated with the request;
pushing the long entry to a message queue;
duplicating the entry across the plurality of buffers;
waiting for an acknowledgment from each of the plurality of buffers; and
responsive to an acknowledgment from each of the plurality of buffers, designating the log entry as committed.

11. The computer-implemented method of claim 10, wherein the message queue comprises a fixed-size double-ended queue.

12. The computer-implemented method of claim 1, wherein each of the plurality of buffers comprises a circular array of fixed size.

13. The computer-implemented method of claim 1, wherein the plurality of applications is associated with a content streaming platform.

14. A non-transitory computer-readable storage medium including instructions that, when executed by a processor, cause the processor to perform the steps of:
receiving a request to modify a record in a snapshot of a dataset, wherein the snapshot comprises a compressed plurality of records replicated across a plurality of applications, and wherein the snapshot is co-located in memory associated with each application;
duplicating an entry comprising information associated with the request across a plurality of buffers, wherein each buffer tracks modification requests associated with the snapshot, and wherein each of the plurality of applications accesses a buffer of the plurality of buffers to receive and store the entry in a portion of memory separate from the dataset, wherein the portion of the memory is accessed in response to a read request associated with the record that is received prior to the snapshot being modified in accordance with the request;
modifying the snapshot in accordance with the request; and
transmitting the modified snapshot to the plurality of applications, wherein the snapshot at each of the plurality of applications is replaced with the modified snapshot.

15. The non-transitory computer readable media of claim 13, wherein the plurality of applications are associated with a content streaming platform.

16. The non-transitory computer readable media of claim 14, wherein the dataset comprises metadata describing various characteristics of videos.

17. The non-transitory computer readable media of claim 14, wherein the request to modify the record includes at least one of adding, modifying, deleting or conditionally updating the record.

18. The non-transitory computer readable media of claim 14, wherein the portion of memory comprises a hash table of updates to records in the snapshot that have not been reflected in the plurality of records included in the snapshot.

19. A system comprising:
a memory storing an application associated with a read-after-write snapshot engine; and
a processor coupled to the memory, wherein when executed by the processor, the read-after-write snapshot engine causes the processor to:
receive a request to modify a record in a snapshot of a dataset, wherein the snapshot comprises a compressed plurality of records replicated across a plurality of applications, and wherein the snapshot is co-located in memory associated with each application;
duplicate an entry comprising information associated with the request across a plurality of buffers, wherein each buffer tracks modification requests associated with the snapshot, and wherein each of the plurality of applications accesses a buffer of the plurality of buffers to receive and store the entry in a portion of memory separate from the dataset, wherein the portion of the memory is accessed in response to a read request associated with the record that is received prior to the snapshot being modified in accordance with the request;
modify the snapshot in accordance with the request; and
transmit the modified snapshot to the plurality of applications, wherein the snapshot at each of the plurality of applications is replaced with the modified snapshot.

20. The system of claim 19, wherein each of the plurality of buffers comprises a circular array of fixed size.
